(19) United States
(12) Patent Application Publication
(10) Pub. No.: US 2013/0335694 A1
(43) Pub. Date: Dec. 19, 2013

(54) PERSONALIZED EYEGLASSES

(71) Applicant: MING CHUAN HUANG, Taipei Hsien (TW)

(72) Inventor: MING CHUAN HUANG, Taipei Hsien (TW)

(21) Appl. No.: 13/495,012

(22) Filed: Jun. 13, 2012

(51) Int. Cl. G02C 11/02; G02C 1/00

(52) U.S. Cl. 351/51; 351/41

(57) ABSTRACT

A pair of personalized eyeglasses comprises two lenses; a lens frame having a lens retaining portion for retaining the two lenses and two supporting rods extending from two sides of the lens retaining portion; and at least one texture area; texts on the texture area being on the lens frame or the lenses, or concaved into a surface of the lens frame or the lenses; or protruded from a surface of the lens frame or the lenses. The texts are at least one of names of users, address of users, ID numbers of users, phone numbers of users, birthdays of users, and data about the user's personal profiles; or the texts are about greeting, alerting, congratulations, anniversaries; or the data shown on the texture area is a section of article.

### FIELD OF THE INVENTION

The present invention related to eyeglasses, in particular to a pair of personalized eyeglasses.

### BACKGROUND OF THE INVENTION

In the prior art, the shape and construction of an eyeglass is dull and simple so that they are not deeply accepted by young peoples. Recently, a variety of many different shapes of eyeglasses are developed to attract the attentions of people in different societies.

A current trend of eyeglasses is to add varieties of patterns or drawings on lateral sides of lens frames to cause the eyeglasses are more vivid than the prior art ones. However, these designs cannot match the requirement of individual users. For example, maybe one desires to have his (or her) to be engraved on the eyeglasses.

Thus from above discussion, it is known that there is an eager demand for novel eyeglasses which can improve the prior art defects so as to satisfy the user's requirements.

### SUMMARY OF THE INVENTION

Accordingly, the object of the present invention is to provide personalized eyeglasses. The design of the present invention provides a function of showing personalized data on eyeglasses with lower cost so as to match the requirement of many people, especially, young people.

To achieve above object, the present invention provides a pair of personalized eyeglasses, comprising: two lenses; a lens frame having a lens retaining portion for retaining the two lenses and two supporting rods extending from two sides of the lens retaining portion; and at least one texture area; texts on the texture area being on the lens frame or the lens, or concaved into a surface of the lens frame or the lens; or protruded from a surface of the lens frame or the lens.

The texts are at least one of names of users, address of users, ID numbers of users, phone numbers of users, birthdays of users, and data about the user's personal profiles. The texts are about greeting, alerting, congratulations, anniversaries. The data shown on the texture area is a section of article.

A way for forming the texts is one of laser engraving, engraving, printing, molding, etching and embedding, punching, forging, or the combination of above ways. Furthermore, a layer of metal or paint is coated on the text by electrically plating, chemically plating, sputtering, paint-baking and gilding with metal or gold.

### BRIEF DESCRIPTION OF THE DRAWINGS

FIG. 1 is a schematic view showing the first embodiment of the present invention.

FIG. 2 is a schematic view showing the second embodiment of the present invention.

FIG. 3 is a schematic view showing the third embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

An eyeglass frame 10 includes the following elements.

Two lenses 30 are included.

A lens frame 20 includes a lens retaining portion 21 for retaining the two lenses 30 and two supporting rods 40 extending from two sides of the lens retaining portion 21. As the eyeglasses 10 are used, the supporting rods 40 are supported by user's ear. A distal end 41 of each supporting rod 40 is curved to fit user's ears.

At least one texture area 50 includes at least one text which is machined to be formed on lens frame 20, that is, the at least one text is formed on the lens retaining portion 21 or the supporting rods 40.

The text is on the surface of the lens frame or concaved into a surface of the lens frame 20 or protruded from a surface of the lens frame 20.

The text shows the data about the names of users, address of users, ID numbers of users, phone numbers of users, birthdays of users, and data about the user's profiles. Furthermore, the data are about greeting, alerting, congratulations, anniversaries, etc.; or the data shown on the texture area 50 is a section of textures.

The ways for forming the texts includes laser engraving, engraving, printing, molding, etching and embedding, punching, forging, etc. or the combination of above ways.

Furthermore, a layer of metal or paints can be coated on the text by electrically plating, chemically plating, sputtering, paint-baking and gilding with metal or gold.

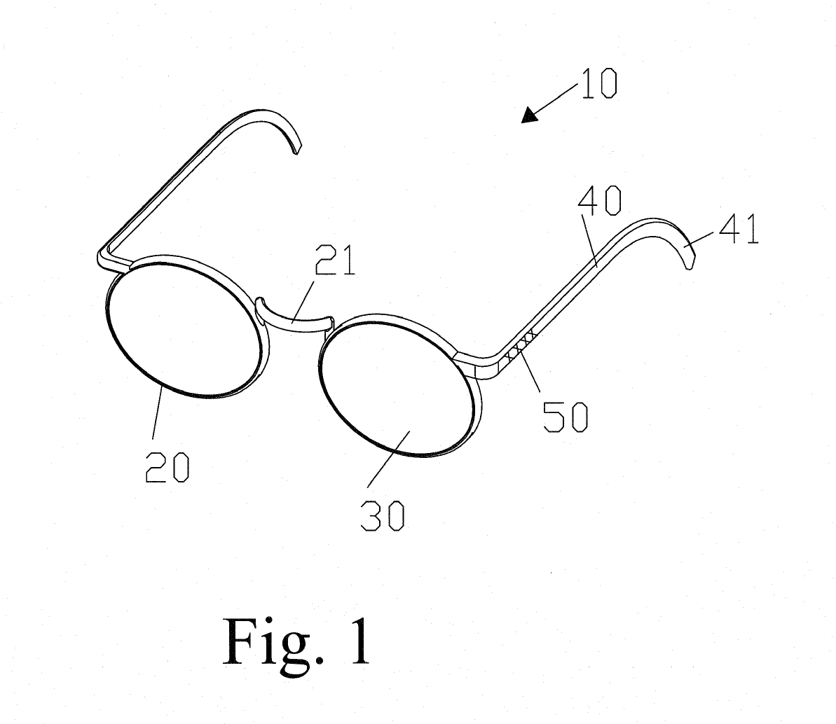

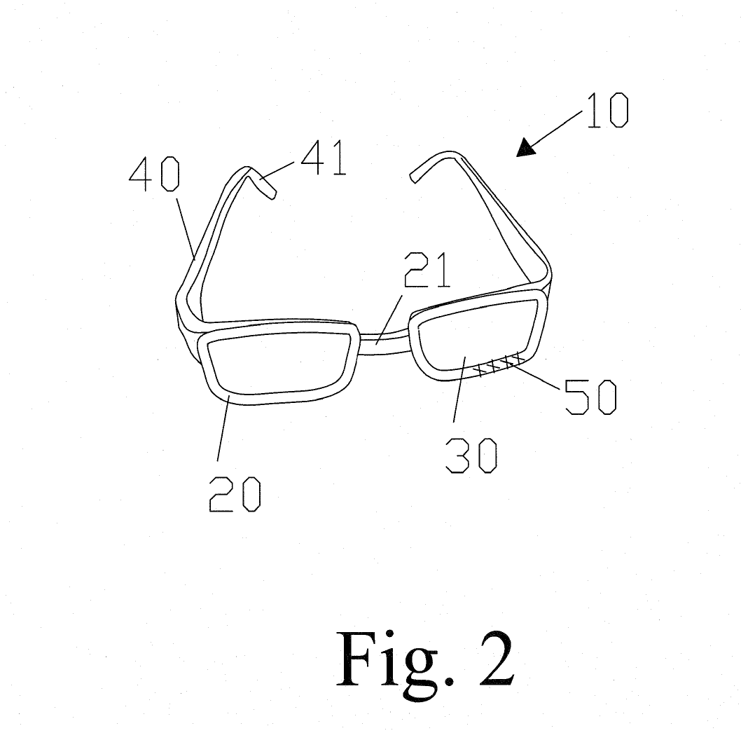

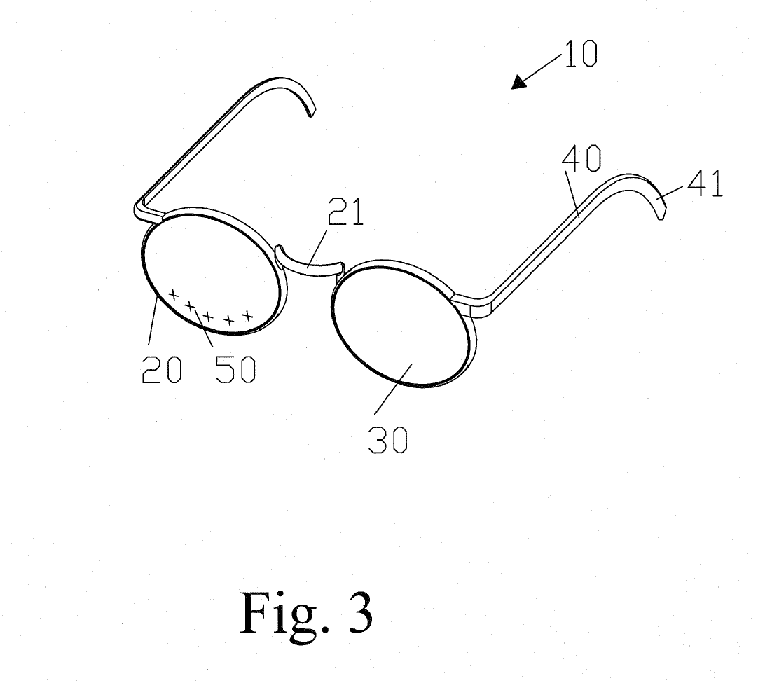

In FIG. 1 of the present invention, it is illustrated that the texture area 50 is formed on the supporting rod 40 of the lens frame 20. In FIG. 2, the texture area 50 is formed on the lens retaining portion 21. Referring to FIG. 3, it is illustrated that the texture area 50 is formed on the lenses 30.

Although in the prior art, figures are shown on the lens frame or lenses of an eyeglasses, however, these figures can not shown the personal data of users. It is not a personalized product, while current people have an eager demand to present personal character on his (or her) object. Eyeglasses are very common commodities, which are almost owned by every person. Thus the design of the present invention is suitable to achieve mentioned object with a very low cost.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A pair of personalized eyeglasses, comprising:
two lenses;
a lens frame having a lens retaining portion for retaining the two lenses and two supporting rods extending from two sides of the lens retaining portion; and
at least one texture area having texts thereon; texts on the texture area being on a surface of the lens frame, or concaved into a surface of the lens frame or protruded from a surface of the lens frame.

2. The pair of personalized eyeglasses as claimed in claim 1, wherein the texts are at least one of names of users, address of users, ID numbers of users, phone numbers of users, birthdays of users, and data about the user's personal profiles.

3. The pair of personalized eyeglasses as claimed in claim 1, wherein the texts are about greeting, alerting, congratulations, and anniversaries.

4. The pair of personalized eyeglasses as claimed in claim 1, wherein the data shown on the texture area is a section of an article.

5. The pair of personalized eyeglasses as claimed in claim 1, wherein a way for forming the texts is one of laser engraving, engraving, printing, molding, etching and embedding, punching, forging, or the combination of above ways.

6. The pair of personalized eyeglasses as claimed in claim 1, wherein a layer of metal or paint is coated on the texts by electrically plating, chemically plating, sputtering, paint-baking and gilding with metal or gold.

7. A pair of personalized eyeglasses, comprising:
two lenses;
a lens frame having a lens retaining portion for retaining the two lenses and two supporting rods extending from two sides of the lens retaining portion; and
at least one texture area having texts thereon; texts on the texture area being on a surface of the lenses; or concaved into a surface of the lenses or protruded from a surface of the lenses.

8. The pair of personalized eyeglasses as claimed in claim 7, wherein the texts are at least one of names of users, address of users, ID numbers of users, phone numbers of users, birthdays of users, and data about the user's personal profiles.

9. The pair of personalized eyeglasses as claimed in claim 7, wherein the texts are about greeting, alerting, congratulations, anniversaries.
